(19) United States
(12) Patent Application Publication
(10) Pub. No.: US 2019/0245583 A1
(43) Pub. Date: Aug. 8, 2019

(54) COMMUNICATION METHOD AND SYSTEM FOR MODULES INTERCONNECTED BY POWER LINE COMMUNICATION

(71) Applicant: SAFRAN ELECTRICAL & POWER, Blagnac Cedex (FR)

(72) Inventors: Marc Christophe TREBOSC, Blagnac Cedex (FR); Thomas LEBOUTEILLER, Moissy-Cramayel Cedex (FR)

(73) Assignee: SAFRAN ELECTRICAL & POWER, Blagnac Cedex (FR)

(21) Appl. No.: 16/314,511

(22) PCT Filed: Jul. 6, 2017
(86) PCT No.: PCT/FR2017/051839

§ 371 Date: Dec. 31, 2018

(30) Foreign Application Priority Data
Jul. 7, 2016 (FR) 1656550

(51) Int. Cl. H04B 3/54; H04B 1/707; H04L 27/26

(52) U.S. Cl. CPC H04B 3/542; H04L 27/2601; H04B 1/707

(57) ABSTRACT

A communication method for communication between communication modules interconnected over an electricity network by a wired connection using power line communication conveyed over the wired connection, the method including prior to a communication module transmitting a data signal, a step of frequency modulating the data signal for transmission; after or during the step of modulating the data signal, a step of direct-sequence spreading of the spectrum of the data signal for transmission; and after a communication module receives a data signal, a step of frequency demodulation of the received data signal and a step of direct-sequence unspreading of the spectrum of the received data signal.

### BACKGROUND OF THE INVENTION

The invention relates to the field of power line communication. More precisely, the invention relates to a method and to a system for communication between communication modules that are interconnected by a wired connection over an electricity network by using power line communication. The proposed communication method and system can be used in particular for onboard systems in aviation.

The technique for transmitting data by power line communication (PLC) serves to exchange digital data between a plurality of communication modules via a wired network constituted by pre-existing mains power supply lines, typically at 230 volts (V) and 50 hertz (Hz) in Europe. For this purpose, information is exchanged from one module to another by modulating one or more carriers in a frequency band that generally lies in the range 2 megahertz (MHz) to 30 MHz, as described in Document EP 2 403 151.

An architecture that is commonly implemented for transmitting digital data by power line communication between different communication modules, e.g. between modems, relies on a method of half-duplex bidirectional communication. An example of that architecture, shown in FIGS. 1a and 1b comprises a master communication module 1 interconnected by a physical channel, namely a wired connection 2, with one or more slave communication modules 3-1, 3-2, 3-3. Access to the physical channel by the various communication modules take place using a method of time division multiple access (TDMA). Communication between the master communication module 1 and the slave modules 3-1, 3-2, 3-3 then takes place in a plurality of steps. By way of example, the master 1 begins by sending a request (arrow I in FIG. 1a) to one or more slaves 3-1, 3-2, 3-3, after which the slaves respond (arrows II in FIG. 1b) one after another. Each slave communication module 3-1, 3-2, 3-3 thus has a transmission time allocated thereto.

Nevertheless, in such an architecture, increasing the number of slave communication modules 3-1, 3-2, 3-3 implies reducing the communication time that is allocated to each of them. Furthermore, for a communication architecture that is unchanging, in particular in terms of specifications concerning its various protocol layers and its physical layer, increasing the number of slave communication modules 3-1, 3-2, 3-3 imposes increasing the communication data rate. Thus, the constraints of distributing communication time allocations to each slave communication module 3-1, 3-2, 3-3 can become severe. Increasing the number of slave communication modules 3-1, 3-2, 3-3 therefore makes implementing that architecture more complex and greatly limits its viability.

It would therefore be desirable to relax the constraints imposed by the application layers on the architecture of the physical layer over which digital data is transmitted by power line communication.

One solution for mitigating the above-mentioned limits would be to use a method of full-duplex bidirectional communication, as shown in FIG. 2, then allowing a plurality of communication modules, be they the master 1 or slaves 3-1, 3-2, 3-3, to transmit simultaneously (arrows III) over the same physical channel, i.e. the wired connection 2 for power line communication.

Nevertheless, such a solution needs to comply with a certain number of constraints, and in particular:
data transmission by power line communication between the various communication modules must make high data rates available, specifically data rates of the order of several megabits per second (Mb/s);
the proposed architecture must be capable of compensating for variations in the physical channel, such as multiple paths, interference, the transfer function of the channel, or indeed narrow band noise (e.g. frequency disturbances encountered in the power cables of an airplane);
it must present modularity with little complexity. In particular, the proposed solution must make it possible to add and/or to replace any PLC type communication module without impacting the performance of the architecture; and
for transmitting data by power line communication in the context of onboard systems in aviation, it is necessary to comply with the transmission characteristics specified in the DO160 standard.

Several solutions could be envisaged for implementing a full-duplex bidirectional architecture using power line communication.

A first solution would be to consider a method of frequency division multiple access (FDMA) for accessing the physical channel, in combination with simple modulation (e.g. binary phase shift keying (BPSK), quadrature phase shift keying (QPSK)) in order to obtain high data rates.

Nevertheless, such a solution leads to problems of frequency synchronization between the communication modules associated with the carrier frequencies. Furthermore, such a solution is found to be limited when compensating for variations in the physical channel.

Orthogonal frequency division multiplexing (OFDM) with carriers being shared between the various communication modules could mitigate the drawbacks of the above solution. Specifically, with OFDM, problems involving frequency synchronization of the carriers do not exist, since the modulation is performed in baseband. Furthermore, such a solution can compensate for defects in the physical channel by equalizing the subcarriers and deactivating any subcarriers for which transmission takes place poorly.

Nevertheless, in that solution, access to frequency resources becomes limited as the number of communication modules is progressively increasing. Data rates will therefore decrease. Furthermore, such a solution implies strong limits on the techniques for time synchronization between the communication modules, where such synchronization is at present invariable in the time/frequency domain.

A third solution would consist in combining the FDMA access method with OFDM modulation. Each communication module would then use OFDM modulation, while communicating over certain pre-allocated carriers and/or frequency bands only.

Nevertheless, such a solution is not very modular and it lacks flexibility: replacing a communication module in the architecture, or inserting a new communication module, would require burdensome dynamic management of that module, e.g. monopolizing a predetermined frequency band. Once more, such a solution also imposes strong limitations on the time synchronization technique that can be used between the various communication modules.

As they stand at present, none of the above-mentioned solutions is found to be pertinent for providing full-duplex bidirectional communication between communication modules that are interconnected by a wired connection and that exchange data by power line communication, while also complying with the above-mentioned constraints.

### OBJECT AND SUMMARY OF THE INVENTION

An object of the present invention is to remedy the above-mentioned drawbacks. More precisely, in the context of full-duplex bidirectional communication making use of a technique of data transmission by power line communication, the present invention seeks to propose a solution that provides high data rates (of the order of several Mb/s), that is little affected by variations in the physical channel, and that is modular and flexible.

To this end, the invention provides a communication method for communication between communication modules interconnected over an electricity network by a wired connection using power line communication (PLC) conveyed over the wired connection, the method comprising:
prior to a communication module transmitting a data signal, a step of frequency modulating the data signal for transmission;
after or during the step of modulating the data signal, a step of direct-sequence spreading of spectrum of the data signal for transmission; and
after a communication module receives a data signal, a step of frequency demodulation of the received data signal and a step of direct-sequence unspreading of the spectrum of the received data signal.

Advantageously, associating a direct-sequence spread spectrum (DSSS) technique with frequency modulation makes it possible for a plurality of data signals from distinct communication modules to be transmitted simultaneously over a common wired connection using power line communication. It is thus possible, in particular, to reduce the power level at which each data signal is transmitted, so as to cause that level to approach a threshold that is close to noise. Using a DSSS technique also makes it possible to distinguish between data signals from different communication modules in the context of full-duplex bidirectional communication.

This solution also makes it possible to improve the confidentiality of data exchanged between the communication module. Specifically, a received signal cannot be unspread and then identified by a communication module receiving the data signal unless that module has an appropriate unspreading sequence. spectrum spreading also makes it possible to give the transmitted data signal immunity against the risk of narrow-band disturbance that exists on the wired connection, such as radiated radiofrequency (RF) disturbances.

In an aspect of the communication method, the modulation and demodulation steps are performed by orthogonal frequency division multiplex (OFDM) modulation and demodulation respectively.

Advantageously, the use of OFDM modulation associated with a DSSS technique makes it possible to deliver high data transmission rates (of the order of several megabits per second) that do not vary, for multimodule transmissions taking place simultaneously.

In another aspect of the communication method, the step of DSSS unspreading of the data signal is performed before or during the step of demodulating the data signal.

In another aspect, the communication method further comprises:
on first connection of a first communication module to the wired connection to which there is already connected a second communication module that is to communicate with said first communication module, a step of said first module transmitting a connection key to the second communication module;
after the second communication module has received said connection key, a step of said second communication module transmitting a communication key to said first communication module; and
the first communication module and the second communication module making use of the communication key during the DSSS spectrum spreading and unspreading steps on the data signal.

The invention also provides a communication system comprising a plurality of communication modules interconnected over an electricity network by a wired connection using power line communication PLC conveyed over the wired connection, each communication module having modulator means configured to perform frequency modulation on a data signal for transmission before it is transmitted, and demodulator means configured to perform frequency demodulation on a data signal after it has been received, each communication module further comprising spreader means configured to perform direct-sequence spread spectrum spreading of the data signal for transmission after or during modulation of the data signal by the modulator means, and unspreader means configured to perform direct-sequence spread spectrum unspreading of the received data signal.

In an aspect of the communication system, the modulator and demodulator means are configured to perform orthogonal frequency division multiplex modulation and demodulation respectively.

In another aspect of the communication system, the unspreader means are configured to perform DSSS unspreading of the data signal before or during demodulation of the data signal by the demodulator means.

In another aspect, the communication system comprises a first communication module and a second communication module for communicating with said first communication module, the first communication module being configured, on first connection to the wired connection, to transmit a connection key to said second communication module, said second communication module, after receiving said connection key, being configured to transmit a communication key to said first communication module, the spreader and unspreader means of said first communication module and of said second communication module also being configured to use the communication key to perform DSSS spreading and unspreading of the data signal.

### BRIEF DESCRIPTION OF THE DRAWINGS

Other characteristics and advantages of the invention appear from the following description of particular embodiments of the invention, given as non-limiting examples and with reference to the accompanying drawings, in which:

FIGS. 1a and 1b, described above, show an architecture for digital data transmission by power line communication between various communication modules using a half-duplex directional communication method as performed in the prior art;

FIG. 2, described above, shows in simplified manner an architecture for transmitting digital data by power line communication between various communication modules using a full-duplex bidirectional communication method;

FIG. 3 is a diagram showing a string of stages in the transmission of a data signal from a first communication module to a second communication module in an embodiment of the invention;

FIG. 4 is a flow chart of a method of communication between the first communication module and the second communication module of FIG. 3 in an implementation of the invention; and

FIG. 5 is a flow chart showing a method of communication as implemented during first connection of a communication module in an embodiment of the invention.

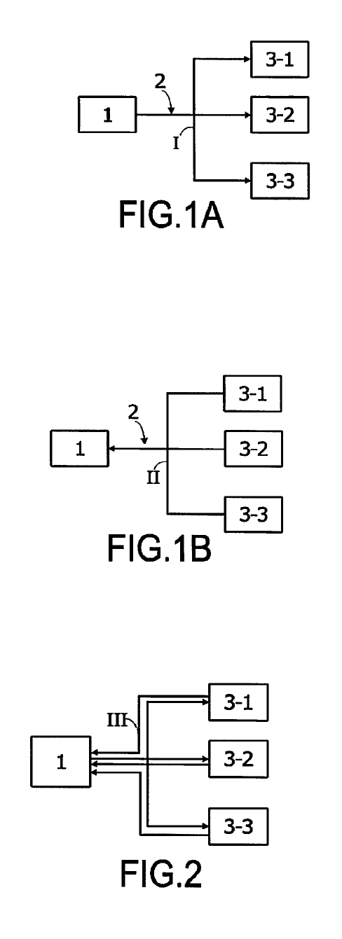

### DETAILED DESCRIPTION OF EMBODIMENTS

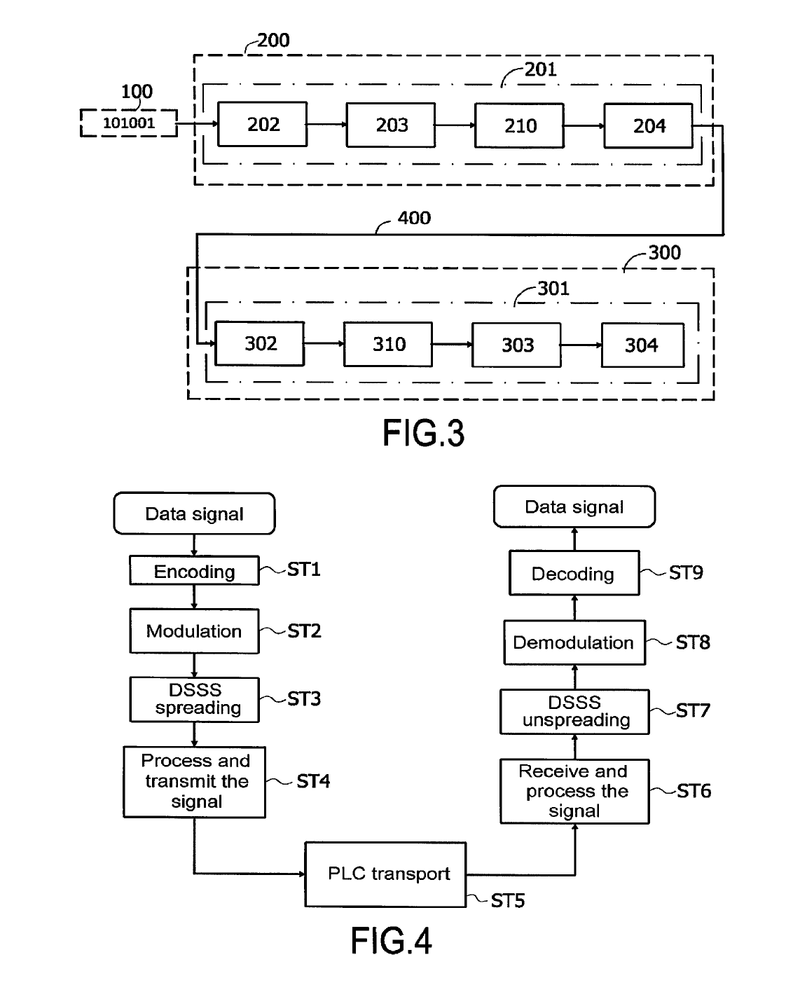

FIG. 3 is a simplified diagram showing a string of stages in the transmission of a data signal 100 from a first communication module 200 to a second communication module 300 that are interconnected over an electricity network by a wired connection 400.

The data signal 100 is conveyed from the first module 200 to the second module 300 by power line communication (PLC) conveyed over the wired connection 400.

By way of example, the communication modules 200, 300 that are shown could equally well be a slave module and a master module, or two slave modules. In addition, in general manner, it is possible to use the wired connection 400 to interconnect an arbitrary number of communication modules.

The first communication module 200 comprises an transmitter unit 201 conventionally comprising encoder means 202, modulator means 203, and transmitter means 204.

The encoder means 202 for encoding the data signal 100 are configured in this example to receive the data signal 100 and to associate an error correcting code with the data signal in order to limit potential data transmission errors over the wired connection 400.

The modulator means 203 are coupled to the outlet of the encoder means 202 and are configured to perform frequency modulation of the data signal encoded by the encoder means 202.

The transmitter means 204 are configured to shape the data signal as frequency modulated by the modulator means 203 and send it over the wired connection 400 addressed to the second communication module 300. The transmitter means 204 may for example be constituted by a front-end type circuit comprising in succession a digital-to-analog converter and a coupler for transmitting the signal over the wired connection 400.

In accordance with the invention, the transmitter unit 201 of the first communication module 200 also comprises spreader means 210 connected between the modulator means 203 and the transmitter means 204. The spreader means 210 are configured to perform direct-sequence spread spectrum (DSSS) spreading of the frequency modulated data signal.

The DSSS spectrum spreading is performed by using the Kronecker tensor product to multiply the modulated digital data signal with a pseudo-random sequence used as a spreading sequence.

Advantageously, the pseudo-random sequence used on transmitting the signal is selected so as to present weak cross-correlation between two different sequences and strong cross-correlation for the same sequence, i.e. strong auto-correlation.

The DSSS spectrum spreading is preferably applied to a data signal that has been modulated using multi-carrier frequency modulation.

In the embodiment shown in FIG. 3, the modulation is orthogonal frequency division multiplexing (OFDM) modulation.

Associating OFDM modulation with DSSS spectrum spreading is particularly advantageous since OFDM modulation serves to deliver communication at high data rates (of the order of several megabits per second), while spectrum spreading enables each data signal to be transmitted at a low power level, close to noise. The spread signal then presents greater immunity when faced with narrow-band noise and with disturbances, due in particular to the multiple paths that can occur over the wired connection 400. Furthermore, spectrum spreading makes it possible to transmit a plurality of data signals simultaneously over the wired connection 400 without those signals interfering mutually, since said signals are spread using different pseudo-random frequencies. DSSS spectrum spreading thus serves to keep separate the data signals from the different communication modules when performing full-duplex bidirectional communication.

In the embodiment shown in FIG. 3, the spreader means 210 are arranged after the modulator means 203. Spectrum spreading is thus performed after frequency modulation of the data signal 100.

In another embodiment that is not shown, it is possible to combine the spreader means 210 with the modulator means 203. Spectrum spreading is performed during frequency modulation of the data signal 100. By way of example, if the modulator means 203 implement OFDM modulation, the spectrum spreading may be performed immediately after the inverse Fourier transform commonly implemented when performing OFDM modulation.

Advantageously, the DSSS spectrum spreading of the data signals after or during frequency modulation enables full-duplex bidirectional communication to be carried out between the various communication modules. Conversely, a step of spreading the spectrum of the data signals before the modulation step would not make full-duplex communication possible. Specifically, modulating the various data signals over the same frequency band and over the same time period would lead to mixing of the data signals from the various communication modules. It is specifically necessary to associate a key with each data signal, i.e. a code that is obtained by oversampling each signal, for the purpose of keeping separate the data signals from the various different communication modules. Once each key has been allocated, a modulation step then results in a loss of the oversampling and thus in a loss of the key serving to distinguish between the data signals from the various different communication modules.

The second communication module 300 comprises a receiver unit 301 conventionally comprising receiver means 302, demodulator means 303, and decoder means 304.

The receiver means 302 have their input connected to the wired connection 400 and they are configured to receive the data signal delivered by the first communication module 200 and conveyed over the wired connection 400. By way of example, these receiver means 302 are constituted by a front-end type circuit comprising in succession: a coupler for receiving the signal from the wired connection 400; a gain amplifier; and an analog-to-digital converter for digitizing the received data signal.

The demodulator means 303 are connected to the output of the receiver means 302. They are configured to perform frequency demodulation on the digitized data signal as received by the receiver means 302.

The data signal decoder means 304 are configured in this example to apply the error correcting code to the data signal as demodulated by the demodulator means 303, so as to obtain the data signal 100.

In accordance with the invention, in order to be able to unspread the signal on reception, the receiver unit 301 of the second communication module 300 includes unspreader means 310 configured to perform unspreading of the direct-sequence spread spectrum of the received data signal.

A data signal that is spread on being transmitted by using a pseudo-random binary sequence, and that is then received by a communication module, can be unspread only if the communication module knows the pseudo-random binary sequence that was used on transmission. The second communication module 300 thus knows the pseudo-random sequence used by the first communication module 200.

In the embodiment shown, unspreading is then performed by using a scalar product to multiply the received data signal with the pseudo-random binary sequence. By way of example, the pseudo-random binary sequence is a Kasami code.

The unspreader means 310 are arranged ahead of the demodulator means 303. Spectrum unspreading is thus performed before frequency demodulation of the data signal 100.

In another embodiment that is not shown, it is possible to combine the unspreader means 310 with the demodulator means 303. Spectrum unspreading is then performed during frequency demodulation of the data signal 100. By way of example, if the demodulator means 303 perform OFDM demodulation, the spectrum unspreading may be performed immediately before the Fourier transform that is commonly implemented when performing OFDM demodulation.

In order to keep FIG. 3 simple, only the output unit 201 of the first communication module 200 and the receiver unit 301 of the second communication module are shown. Nevertheless, each of the communication modules 200, 300 is capable both of transmitting and of receiving a data signal 100. The communication modules 200 and 300 thus all have their own transmitter units and their own receiver units, which are made respectively in similar manner to the transmitter unit 201 and the receiver unit 301.

Advantageously, each communication module 200, 300 has its own pseudo-random binary sequence that it uses when spreading the spectrum of a data signal 100 for transmission. As a result, a received data signal that has previously been spread with a pseudo-random binary sequence by a transmitter communication module can be unspread by a different communication module only if it has knowledge of that pseudo-random binary sequence.

A plurality of data signals having their spectra spread by different communication modules using respective pseudo-random binary sequences can thus be transmitted simultaneously over the wired connection 400. Each communication module 200, 300 must therefore be capable of identifying a data signal that is addressed thereto.

Thus, in an embodiment, the unspreader means 310 may comprise, or be associated with, time synchronization means for detecting whether a data signal received from the wired connection 400 is or is not addressed to the communication module receiving the signal. By way of example, after digitizing a received data signal, the time synchronization means are configured to use a moving window in order to detect a predetermined preamble or a predetermined pseudo-random binary sequence.

FIG. 4 shows a particular implementation of a communication method between the first communication module 200 and the second communication module 300, with reference to the embodiment shown in FIG. 3.

For a data signal that is to be transmitted, the first communication module 200 performs the following operations:
encoding (step ST1) the data signal 100 for transmission by the first communication module 200, by way of example by associating an error correcting code with the data signal;
modulating the encoded signal (step ST2), preferably using multicarrier frequency modulation, e.g. OFDM modulation, in order to guarantee a high data rate for the transmitted signal;
DSSS spreading (step ST3) of the modulated signal, by using a tensor product to multiply the modulated signal with a predetermined pseudo-random binary sequence (spreading sequence); and
processing and transmitting (step ST4) the spread signal over the wired connection 400, the processing and sending of the signal consisting, by way of example, in digital-to-analog conversion of the signal followed by coupling the signal to the wired connection 400.

The transmitted data signal is then transported (step ST5) over the wired connection 400 using power line communication (PLC) to the second communication module 300, which then performs the following operations:
receiving and processing (step ST6) the signal conveyed over the wired connection 400, where receiving and processing the signal consists, by way of example, in coupling the signal received via the wired connection 400, followed by gain amplification and by analog-to-digital conversion of the signal;
DSSS unspreading (step ST7) of the modulated signal by using a scalar product to multiply the modulated signal with the predetermined pseudo-random binary sequence (spreading sequence) used by the first communication module 200; in one implementation, this step may be preceded by or combined with a time synchronization step that consists in identifying the received signal, e.g. by using a moving window for detecting a predetermined preamble or a predetermined pseudo-random binary sequence;
demodulating (step ST8) the unspread signal, in compliance with the modulation used during transmission of the data signal, e.g. by OFDM demodulation of the unspread signal; and
decoding (step ST9) the demodulated signal, e.g. by applying an error correcting code to the demodulated signal so as to obtain as output the initial data signal, without data transmission errors.

As set out above, the above-described communication method relates to a particular embodiment corresponding to the transmission system shown in FIG. 3. In general manner, and in accordance with the invention, care is taken to perform at least the following steps: modulation/demodulation, preferably but not necessarily by OFDM modulation/demodulation, together with spectrum spreading/unspreading steps by direct-sequence spectrum spreading (DSSS). Specifically, these steps are essential for providing both high data rates and for allowing data signals to be transmitted simultaneously by different communication modules without running the risk of interference between the various signals or of transmission errors while the signals are being transported over the wired connection 400 by power line communication (PLC).

Furthermore, as set out in the introduction, the communication modules that are interconnected by the wired connection 400 need to present an architecture that is modular and flexible, thereby making it easier to replace or to insert any new communication module.

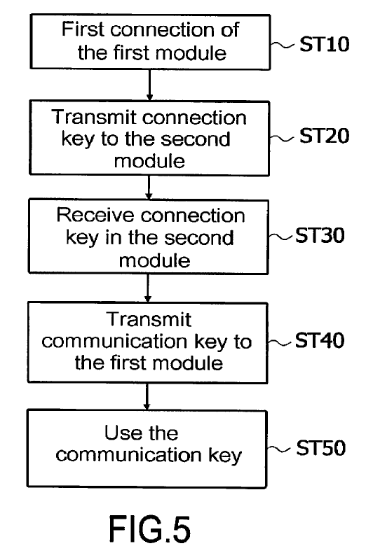

For this purpose, FIG. 5 shows the steps of a method of communication between the first communication module 200 and the second communication module 300 in the situation in which the first communication module 200 is being connected for the first time to the wired connection 400, and in which the second communication module 300 is to communicate with the first communication module 200.

In a first step ST10, the first communication module 200 is connected to the wired connection 400 for the first time.

In a following step ST20, the first communication module 200 then transmits a connection key to the second communication module 300 via the wired connection 400, the connection key previously being associated with the first communication module 200 in order to enable it to be identified. By way of example, the connection key may be transmitted to the second communication module 300 via a binary data frame that is modulated and spread with the connection key.

Thereafter, in a step ST30, the second communication module 300 receives the connection key from the first communication module 200, and after authenticating it, transmits thereto a communication key in return in a step ST40, which communication key is a pseudo-random binary sequence. By way of example, the communication key may be transmitted to the first communication module 200 in the form of a binary data frame that is modulated and then spread with the connection key.

After the first communication module 200 has received the communication key, the spreader and unspreader means of said first communication module 200 and of said second communication module 300 then make use of this particular communication key (step ST50) as a pseudo-random binary sequence for performing the DSSS spreading and unspreading steps ST3 and ST7 for each data signal exchanged between these modules.

Preferably, in the above-described embodiment, the first communication module 200 is a slave communication module and the second communication module 300 is a master communication module.

As a master module, the second communication module 300 is then made in such a manner as to know the connection keys of all of the slave modules, including specifically of the first communication module 200 being connected for the first time to the wired connection 400, and to give each slave module in return a unique communication key that is available. The second communication module 300 thus centralizes in one or more databases the connection keys and the communication keys for each of the slave communication modules.

The master module, in this example the second communication module 300, is also capable of:
unspreading simultaneously the data frame transmitted by a plurality of slave communication modules by using connection keys and/or communication keys that are distinct and specific to each of those slave modules; and
simultaneously allocating a plurality of distinct communication keys to slave communication modules being connected for the first time to the wired connection 400.

The master communication module thus has the task of managing all of the connection/communication keys. Conversely, each slave module, such as the second communication module 300, makes use of a single communication/connection key for unspreading a received data frame.

Advantageously, such a configuration makes it possible to guarantee that the same communication key cannot be allocated to two different slave communication modules.

It is thus possible to create direct communication channels between a master communication module and any of the slave communication modules, and also between slave communication modules. Such communication channels are then characterized by the communication key used during data exchanges between the various communication modules. Such an embodiment thus makes it possible to guarantee modularity and flexibility for an architecture presenting a plurality of communication modules interconnected over an electricity network by a wired connection using power line communication (PLC). This architectural modularity and flexibility is the result in particular of dynamic management of the connection/communication keys being performed by a single master communication module. In various embodiments, the wired connection for PLC may be a twisted two-wire connection for transmitting signals in a differential mode, or a single-wire connection for transmitting signals in a common mode.

Advantageously, all of the above-described embodiments enable a plurality of data signals 100 to be conveyed simultaneously as transmitted by different communication modules over the same wired connection using power line communication (PLC).

In particular, using a DSSS spectrum spreading technique makes it possible to reduce the power level of each transmitted data signal, and to bring this level close to a threshold that is itself close to noise. Using a DSSS technique applied to the frequency band of power line communication (PLC) thus serves to minimize the risk of the data signal being radiated while it is being transported over the wired connection 400, since the level at which the signal is transmitted is low.

Furthermore, the signal-to-noise ratio is improved after unspreading the received data signal, thereby making it possible to make provision against potential errors in the transmission of data over the wired connection 400.

Furthermore, DSSS spectrum spreading makes it possible:
to strengthen the confidentiality of the data exchanged between each communication module, since a received signal can be unspread and then identified only if the receiving communication module has available the appropriate pseudo-random binary sequence; and
to give the transmitted data signal immunity against the risks of narrow-band disturbance of the kind that exists on the wired connection, such as radiated RF disturbances.

Furthermore, associating the DSSS spectrum spreading technique with multicarrier frequency modulation, preferably with OFDM modulation, enables high data transmission rates to be provided (of the order of several megabits per second) that do not vary, for simultaneous multimodule transmissions.

1. A communication method for communication between communication modules interconnected over an electricity network by a wired connection using power line communication conveyed over the wired connection, the method comprising:
prior transmitting ST4 a data signal to a first communication module, frequency modulating ST2 the data signal for transmission;
after or during the modulating the data signal, direct-sequence spreading ST3 of the spectrum of the data signal for transmission; and
after receiving ST6 a data signal from a second communication module, frequency demodulating ST8 of the received data signal and direct-sequence unspreading ST7 of the spectrum of the received data signal.

2. The communication method according to claim 1, wherein the modulating and demodulating steps ST2 ST8 are performed by orthogonal frequency division multiplex modulation and demodulation respectively.

3. The communication method according to claim 1, wherein the direct-sequence spread spectrum unspreading ST7 of the data signal is performed before or during the demodulating ST8 the data signal.

4. The method according to claim 1, further comprising:
on first connection ST10 of a first communication module to the wired connection to which there is already connected a second communication module that is to communicate with said first communication module, transmitting ST20 a connection key of said first module to the second communication module,
after the second communication module has received said connection key, transmitting ST40 a communication key of said second communication module to said first communication module; and
the first communication module and the second communication module making use ST50 of the communication key during the direct-sequence spread spectrum spreading and unspreading ST3, ST7 on the data signal.

5. The communication system comprising a plurality of communication modules interconnected over an electricity network by a wired connection using power line communication conveyed over the wired connection, each communication module having modulator means configured to perform frequency modulation on a data signal for transmission before it is transmitted, and demodulator means configured to perform frequency demodulation on a data signal after it has been received,
wherein each communication module further comprises spreader means configured to perform direct-sequence spread spectrum spreading of the data signal for transmission after or during modulation of the data signal by the modulator means, and unspreader means configured to perform direct-sequence spread spectrum unspreading of the received data signal.

6. The communication system according to claim 5, wherein the modulator and demodulator means are configured to perform orthogonal frequency division multiplex modulation and demodulation respectively.

7. The communication system according to claim 5, wherein the unspreader means are configured to perform direct-sequence spread spectrum unspreading of the data signal before or during demodulation of the data signal by the demodulator means.

8. The communication system according to claim 5, comprising a first communication module and a second communication module for communicating with said first communication module, the first communication module being configured, on first connection to the wired connection, to transmit a connection key to said second communication module, said second communication module, after receiving said connection key, being configured to transmit a communication key to said first communication module, the spreader and unspreader means of said first communication module and of said second communication module also being configured to use the communication key to perform direct-sequence spread spectrum spreading and unspreading of the data signal.
